(19) United States
(12) Patent Application Publication
(10) Pub. No.: US 2003/0177336 A1
(43) Pub. Date: Sep. 18, 2003

(54) Parallelism throttling

(76) Inventor: Neal Bremner Smith, Northumberland (GB)

Correspondence Address: SALTAMAR INNOVATIONS, 30 FERN LANE, SOUTH PORTLAND, ME, 04106, US

(21) Appl. No.: 10/276,635

(22) PCT Filed: May 18, 2001
(86) PCT No.: PCT/GB01/02165

(30) Foreign Application Priority Data
May 19, 2000 (GB) 0011976.8

(51) Int. Cl. G06F 15/76; G06F 15/00

(52) U.S. Cl. 712/1

(57) ABSTRACT

The present invention relates to a system (10) and method of throttling parallelism in a parallel processing system, where the throttle performs the decision with a hardware decision making means (12) and the suspension of thread execution is performed in software (11) and the data related to suspended threads are stored (13) until they are reactivated.

The present invention relates to a system intended for use in parallel processing computers, and in particular throttling of parallelism.

Multi-processor computers are used to execute programs that can utilise parallelism, with concurrent work being distributed across the processors to improve execution speeds. The dataflow model is convenient for parallel execution, with execution of an instruction either on data availability or on data demand, not because it is the next instruction in a list. This also implies that the order of execution of operations is irrelevant, indeterminate and cannot be relied upon.

Data arriving at a processor may be built from a group of tokens (Papadopoulos, G. M.; Traub, K. R.; Multithreading: A Revisionist View of Dataflow Architectures, Ann. Int. Symp. Comp. Arch., pp.342-351, 1991). Such a group is analogous to a register bank in a RISC processor and include items such as status flags and execution addresses, and collectively hold all the information needed to describe the full context of a conceptual thread. Like registers in a RISC machine, none, one, or more tokens in the group can be used by an executing instruction either in conjunction with or in lieu of a memory access. For clarity, within this document, including the statements of invention and claims, a pointer to a group of one or more tokens, is referred to as a ‘thread’, and the token values are collectively referred to as the ‘thread context’.

When a program running on a parallel processing computer creates too many parallel threads, the computer can be overwhelmed and lack resources with which to handle the parallel instruction execution. A throttle is a means to control parallelism and prevent a system from overloading. Throttles can be expensive to implement because hardware based throttling can require complex circuitry, and software based throttling carries large overheads in execution speed. It would be advantageous to provide a system of throttling that incurred small overheads in both circuit complexity and execution speed, while also keeping the parallelism tightly controlled within boundaries.

When an upper boundary on the number of parallel threads is passed because of poor control by a throttle, the result is overshoot. When the throttle fails to reactivate threads below a lower boundary of parallelism, the condition is referred to as undershoot. It would be advantageous to provide a system with a throttle that prevents parallelism exceeding an upper threshold, with very little overshoot, by suspending processes. It would be advantageous to provide a system with a throttle that maintains parallelism above a lower threshold with very low undershoot, if there are previously suspended processes for reactivation.

Software based throttling is open to abuse or neglect by programmers. It would be advantageous to provide a system wherein the software handling of throttling can be made resistant to abuse.

It is an object of the present invention to prevent parallelism exceeding an upper threshold in a parallel processing computer.

It is a further object of this invention to maintain parallelism above a lower threshold in a parallel processing computer.

According to the first aspect of this invention, there is provided a parallel processing system comprising a decision making means for controlling the amount of parallel process execution in said system, a thread control means for the purpose of creating and destroying processing threads, and a context storage means for storing the data relating to said processing threads characterised in that the thread control means is responsive to the decision making means.

Preferably, said thread control means is responsive to the decision making means passing a processing thread to said thread control means.

Preferably, said thread control means is responsive to the decision making means requesting the creation of a processing thread by said thread control means.

Preferably, said decision making means comprises a means for quantifying the amount of parallelism in said parallel processing system.

More preferably, said decision making means comprises a counter which counts the number of concurrent threads in said parallel processing system.

Typically, said counter is updated in response to a thread being created by the thread control means.

Typically, said counter is updated in response to a thread being destroyed by the thread control means.

Preferably, said decision making means comprises decision logic.

More preferably, said decision making means comprises hardware alone.

Preferably, said thread control means comprises a processor and a software program.

Preferably, said software program in said thread control means is responsive to an unmaskable event, e.g. an interrupt.

Preferably, said context storage means comprises computer memory.

More preferably, said context storage means comprises a stack.

Preferably, said context storage means is shared between a plurality of said parallel processing systems.

Preferably, said decision making means is responsive to a hardware flag that indicates that said storage means is empty of thread contexts.

According to a second aspect of this invention, there is provided a method for controlling the amount of parallel process execution in a parallel processing computer comprising the steps of:

a decision making means passing a processing thread to a thread control means;

said thread control means storing the thread context relating to said processing thread in a context storage means;

said thread control means destroying said processing thread;

characterised in that said thread control means is responsive to said decision making means.

According to a third aspect of this invention, there is provided a method for controlling the amount of parallel process execution in a parallel processing computer comprising the steps of:

a decision making means requesting the creation of a processing thread by said thread control means;

said thread control means retrieving the thread context relating to said processing thread from a context storage means;

said thread control means creating said processing thread;

characterised in that said thread control means is responsive to said decision making means.

In order to provide a better understanding of the present invention, an example will now be described by way of example only and with reference to the accompanying Figures, in which:

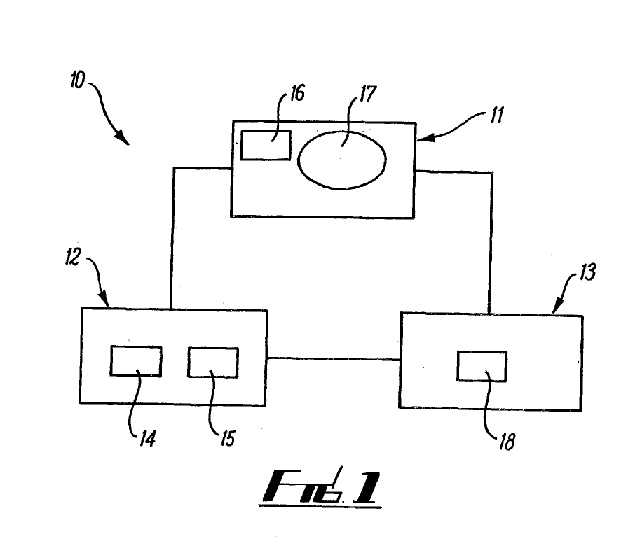

FIG. 1 illustrates the configuration of the system; and

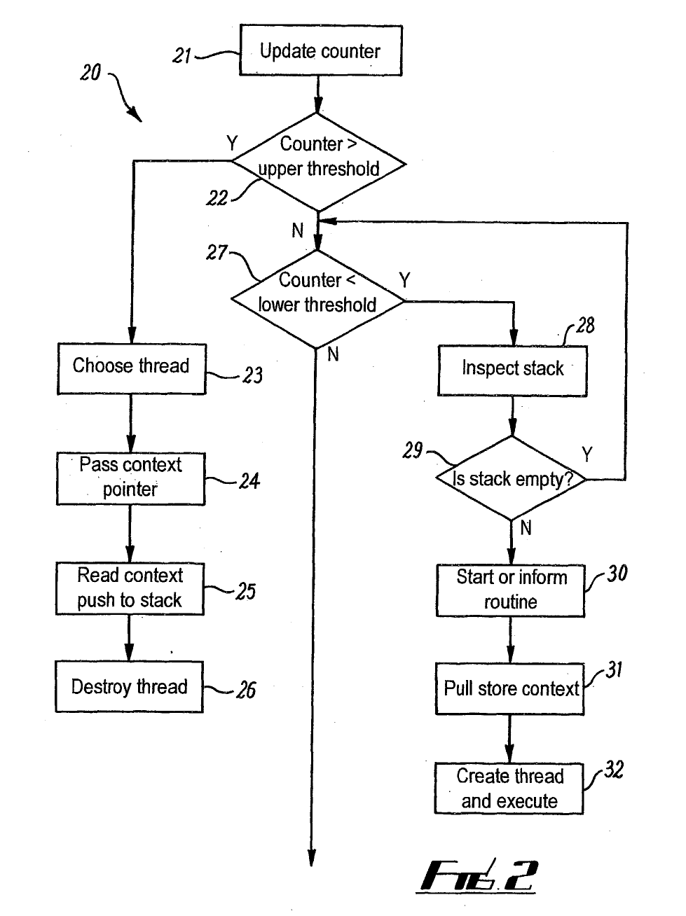

FIG. 2 illustrates a flowchart describing the throttling mechanism.

The invention is a parallelism throttling system which functions to control the amount of parallel processing in a parallel processing system.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

FIG. 1 illustrates, in schematic form, a block diagram of the system in accordance with the invention. The system 10 includes a thread control means 11, decision making means 12 and context storage means 13. The decision making means includes a counter 14 and decision logic 15. The thread control means includes a processor 16 and a software program 17 for the purpose of creating and destroying program threads. The context storage means 13 is a computer memory containing a stack 18 which is preferably a first in, first out stack.

FIG. 2 illustrates a flowchart 20 describing the steps used by the system to control parallelism in accordance with the invention. The decision making means updates the contents of a counter 21, each time a new process thread is created or destroyed. The decision logic compares the contents of the counter with an upper threshold value 22. If the count exceeds an upper threshold, an appropriate unit of parallelism, UOP, e.g., a thread, is chosen from all of those in existence 23 and a reference, (e.g. a context pointer) is passed to a software program 24. The program will read the UOP's context and push it onto a stack 25 and then destroy the UOP 26.

The decision logic compares the contents of the counter with an upper threshold value 27. If the count falls below a lower threshold, the hardware periodically inspects the stack 28 and if a UOP's context is on the stack 29, then another software program is started (or informed if always executing 30). This program pulls the context off the stack 31 and uses it to create a new UOP 32 cloned with same properties of the original. This new UOP is then available for execution.

In a preferred embodiment, the stack is a circular first in, first out stack, held in main RAM and more preferably the software programs will sit on unmaskable event vectors.

Preferably a flag is used to prevent the hardware polling a stack which is known to be empty.

In a dataflow system, the software throttling program may be activated preferably by redirecting data tokens into it, and having it terminated after writing the tokens onto the stack.

Preferably, reactivation of the tokens is achieved by the hardware injecting a token into a software program, which then pulls the original tokens off the stack.

In this invention, the throttle prevents parallelism exceeding an upper threshold, with very little overshoot, by suspending processes and maintains parallelism above a lower threshold with virtually zero undershoot, if there are previously suspended processes available for reactivation. Minimal hardware is required, software overheads are tiny and the system can be made resistant to abuse.

Our method allows a large degree of choice over what rules are applied to decide which instructions are suspended and when, and also if and when to try and resurrect previously suspended instructions. Even complex rules can be implemented with little logic, so the hardware part of the system is very cheap and flexible. The software part is also much more flexible than with the purely hardware throttle, but no more flexible than a purely software throttle can be. If the function of the software is defined by the hardware designer, then the hardware rules can be implemented with knowledge of what the software can and will do. This allows flexibility in the balance of responsibility between the hardware and the software.

Further modifications and improvements may be added without departing from the scope of the invention herein described.

1. A parallel processing system comprising a decision making means for controlling the amount of parallel process execution in said system, a thread control means for the purpose of creating and destroying processing threads, and a context storage means for storing the data relating to said processing threads characterised in that the thread control means is responsive to the decision making means.

2. A system as claimed in claim 1 wherein said thread control means is responsive to the decision making means passing a processing thread to said thread control means.

3. A system as claimed in any preceding claim wherein said thread control means is responsive to the decision making means requesting the creation of a processing thread by said thread control means.

4. A system as claimed in any preceding claim wherein said decision making means comprises a means for quantifying the amount of parallelism in said parallel processing system.

5. A system as claimed in claim 4 wherein said decision making means comprises a counter which counts the number of concurrent threads in said parallel processing system.

6. A system as claimed in claim 5 wherein said counter is updated in response to a thread being created by the thread control means.

7. A system as claimed in any of claims 5 to 6 wherein said counter is updated in response to a thread being destroyed by the thread control means.

8. A system as claimed in any preceding claim wherein said decision making means comprises decision logic.

9. A system as claimed in any preceding claim wherein said decision making means comprises hardware alone.

10. A system as claimed in any preceding claim wherein said thread control means comprises a processor and a software program.

11. A system as claimed in claim 10 wherein said software program is responsive to an unmaskable event.

12. A system as claimed in any preceding claim wherein said context storage means comprises computer memory.

13. A system as claimed in any preceding claim wherein said context storage means comprises a stack.

14. A system as claimed in any preceding claim wherein said context storage means is shared between a plurality of said parallel processing systems.

15. A system as claimed in any preceding claim wherein said decision making means is responsive to a hardware flag that indicates that said storage means is empty of thread contexts.

16. A method for controlling the amount of parallel process execution in a parallel processing computer comprising the steps of:
a decision making means passing a processing thread to a thread control means;
said thread control means storing the thread context relating to said processing thread in a context storage means;
said thread control means destroying said processing thread;
characterised in that said thread control means is responsive to said decision making means.

17. A method for controlling the amount of parallel process execution in a parallel processing computer comprising the steps of:
a decision making means requesting the creation of a processing thread by said thread control means;
said thread control means retrieving the thread context relating to said processing thread from a context storage means;
said thread control means creating said processing thread;
characterised in that said thread control means is responsive to said decision making means.

18. A method as claimed in any of claims 16 to 17 wherein said thread control means is responsive to the decision making means passing a processing thread to said thread control means.

19. A method as claimed in any of claims 16 to 18 wherein said thread control means is responsive to the decision making means requesting the creation of a processing thread by said thread control means.

20. A method as claimed in any of claims 16 to 19 wherein said decision making means comprises a means for quantifying the amount of parallelism in said parallel processing system.

21. A method as claimed in claim 20 wherein said decision making means comprises a counter which counts the number of concurrent threads in said parallel processing system.

22. A method as claimed in claim 21 wherein said counter is updated in response to a thread being created by the thread control means.

23. A method as claimed in any of claims 21 to 22 wherein said counter is updated in response to a thread being destroyed by the thread control means.

24. A method as claimed in any of claims 16 to 23 wherein said decision making means comprises decision logic.

25. A method as claimed in any of claims 16 to 24 wherein said decision making means comprises hardware alone.

26. A method as claimed in any of claims 16 to 25 wherein said thread control means comprises a processor and a software program.

27. A method as claimed in claim 26 wherein said software program is responsive to an unmaskable event.

28. A method as claimed in any of claims 16 to 27 wherein said context storage means comprises computer memory.

29. A method as claimed in any of claims 16 to 28 wherein said context storage means comprises a stack.

30. A method as claimed in any of claims 16 to 29 wherein said context storage means is shared between a plurality of said parallel processing systems.

31. A method as claimed in any of claims 16 to 30 wherein said decision making means is responsive to a hardware flag that indicates that said storage means is empty of thread contexts.
